(19) United States
(12) Patent Application Publication
(10) Pub. No.: US 2017/0235884 A1
(43) Pub. Date: Aug. 17, 2017

(54) Identifying Medical Codes Applicable to a Patient Based on Patient History and Probability Determination

(71) Applicant: International Business Machines Corporation, Armonk, NY (US)

(72) Inventors: Jonathan M. Harmon, Coppell, TX (US); Atul Kumar, Irving, TX (US); Russell G. Olsen, Flower Mound, TX (US); Matt T. Westfall, Irving, TX (US)

(21) Appl. No.: 15/045,539

(22) Filed: Feb. 17, 2016

(51) Int. Cl. G06F 19/00

(52) U.S. Cl. CPC G06F 19/322; G06F 19/325; G06F 19/327; G06F 19/3406

(57) ABSTRACT

Mechanisms are provided for identifying potential medical codes applicable to a patient based on a patient registry record. A patient registry record, in a patient registry, is analyzed to identify current and historical medical information about a corresponding patient. The current and historical medical information is evaluated to identify at least one medical code for which the patient may qualify but is not currently associated with the patient. A probability value for the at least one medical code is calculated based on the current and historical medical information about the corresponding patient. The probability value is compared to at least one threshold value and an alert notification is output indicating the at least one medical code in response to the probability value having a predetermined relationship with the at least one threshold value.

### BACKGROUND

The present application relates generally to an improved data processing apparatus and method and more specifically to mechanisms for identifying missing medical codes for re-coding in patient registry records and mechanisms for updating patient registry records accordingly.

Various programs have been established for compensating medical personnel for treating patients based on the medical codes associated with their patient medical records. With certain programs, if the medical personnel fail to code the patient medical record with an applicable medical code, then the medical personnel may not be properly compensated for the care that they are providing. Due to the large number of patients most doctors and other medical personnel treat, and the detailed nature of the patient records, it is sometimes difficult for doctors and medical personnel to identify such missed opportunities.

For example, a patient may have a medical code entered into their patient medical record in one calendar year, and then in the next calendar year, the medical code may not be re-coded even though the patient is still receiving care from the medical personnel for the same medical condition that existed in the previous year and remains a relevant condition. Thus, the doctor or medical personnel may not receive adequate compensation for the care they are providing. Moreover, the doctor may miss a medical code that applies to the patient even though the patient's symptoms, history, and the like, meet the criteria of the medical code, may code the patient for a correct diagnosis but perhaps not the most appropriate medical code to both classify the patient and maximize compensation for the doctor, or may code the patient for one applicable medical code but miss additional medical codes that should also be applied to the patient based on the patient's symptoms, history, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, for identifying potential medical codes applicable to a patient based on a patient registry record. The method comprises analyzing, by the data processing system, a patient registry record in a patient registry to identify current and historical medical information about a corresponding patient. The method further comprises evaluating, by the data processing system, the current and historical medical information to identify at least one medical code for which the patient may qualify but is not currently associated with the patient. In addition, the method comprises calculating, by the data processing system, a probability value for the at least one medical code based on the current and historical medical information about the corresponding patient. The probability value indicates a probability that the at least one medical code applies to the patient. Moreover, the method comprises comparing, by the data processing system, the probability value to at least one threshold value and outputting, by the data processing system, an alert notification indicating the at least one medical code in response to the probability value having a predetermined relationship with the at least one threshold value.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram illustrating a cloud computing system for providing software as a service, where a server provides applications and stores data for multiple clients in databases according to one example embodiment of the invention;

FIG. 2 is another perspective of an illustrative cloud computing environment in which aspects of the illustrative embodiments may be implemented;

FIG. 3 is an example diagram illustrating a set of functional abstraction layers provided by a cloud computing environment in accordance with one illustrative embodiment;

FIG. 4 is an example block diagram illustrating the primary operational elements of a medical code re-coding engine in accordance with one illustrative embodiment; and

FIG. 5 is a flowchart outlining an example operation for performing medical code re-coding evaluation and notification generation in accordance with one illustrative embodiment.

### DETAILED DESCRIPTION

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In addition, it should be appreciated that the present description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

As noted above, programs of various types, such as government sponsored programs, insurance company sponsored programs, and other private and public party organization based programs, have been established for compensating medical personnel for treating patients based on the medical codes associated with their patient medical records. For example, Medicare, Medicaid, medical insurance payment programs, and the like, have all been established and each have their own sets of rules or criteria that are required for a medical doctor or other medical personnel (hereafter assumed to be a “doctor” for ease of explanation) to be compensated for the care that they provide to their patients. Many times, these rules or criteria are based on medical codes associated with the patient in the patient's medical record. For example, a doctor, when meeting with the patient and providing medical care, must input the correct medical codes into the patient's medical record, typically stored electronically, in order to obtain adequate compensation for the care provided by the doctor to the patient. Thus, if the doctor wishes to receive compensation for treating a diabetes patient with regard to an amputation, then the correct medical codes for diabetic amputation must be input to the patient medical record and corresponding payment system for reporting to the appropriate program supporter, e.g., insurance company, government regulatory agency, or the like.

With such programs, if the doctor of other medical personnel miss coding the patient medical record with an applicable medical code, then the medical personnel may not be properly compensated for the care that they are providing. For example, a doctor may have a patient that uses the United States of America federal health insurance plan referred to as “Medicare” to assist with payment of medical expenses. The Medicare payment methodology may be established such that the doctor is paid a flat fee for treating patients having a particular medical code, e.g., a type 2 diabetes patient with an amputation. In this situation, if the doctor properly enters the medical code for the patient as being a type 2 diabetes patient with an amputation, then the doctor will be paid the flat fee as agreed by Medicare during the year that the patient was coded with this medical code, e.g., the code “L5000”. However, if the doctor uses a different code that is directed to only treating a type 2 diabetes patient, then the doctor may potentially lose compensation due to the doctor for treating a patient that is a type 2 diabetes patient with an amputation. Moreover, the patient's symptoms, history, and the like, may be indicative of other alternative or additional medical codes, that the doctor may have missed, which the doctor should consider to determine if they are applicable to the patient in order to properly classify the patient with regard to both treatment classification and payment provider classification.

The illustrative embodiments provide mechanisms for analyzing the patient's current symptoms, treatments, previous diagnoses within specified time periods, as may be indicated by previously entered medical codes, and other information present in the patient registry record. The illustrative embodiments calculate the probabilities that certain medical codes apply to the patient based on the results of the analysis of the patient's current symptoms and medical code associated with the patient, as well as the information in the medical history of the patient provided in the patient registry record, i.e. the previous medical codes logged in the registry, previous diagnoses, symptoms, treatments, etc. For example, if the patient has been previously coded as pre-diabetic and the patient's history shows the patient is now exhibiting indications or symptoms of complex diabetes, but has not been coded by the physician as such, the probability that the patient has complex diabetes is calculated based on the various pieces of information present in the patient registry record. The particular probability evaluation may be dependent upon the particular medical malady, medical event, or other medical condition associated with a medical code. For example, for complex diabetes, various factors including blood sugar levels, reports of frequent urination, reports of thirst or dry mouth, itchy skin, blurred vision reports, and the like may be variables in a computational probability function with various weight values associated with the factors based on an evaluation of the relative importance of the factors to the calculation of the probability of the result, e.g., complex diabetes. Different factors and weight values may be combined for probability calculations for different possible results which correspond to medical codes. The particular combinations of factors and weight values for calculating probabilities with regard to different results, or medical codes, may be determined by subject matter experts, learned using machine learning techniques, or the like.

Based on the calculated probabilities for one or more medical codes for which the patient's registry record indicates the patient's medical history is indicative of at least some of the pre-requisites, or factors, for the corresponding medical code, a set of medical codes is selected whose probabilities meet or exceed one or more pre-determined threshold probability values. Various threshold probability values may be established for various levels of operation, e.g., one for logging a recommendation in the patient's registry record, another for appending an alert or notification to a patient's scheduled appointment entry in a scheduling system, another for outputting a notification to the doctor directly, or the like. For purposes of the present explanation, it will be assumed that a single threshold is established for either generating an alert/notification or not generating an alert/notification, which may be appended to an appointment entry or otherwise associated with the patient's registry record.

For those medical codes in the set of medical codes whose probability values meet or exceed the pre-determined threshold probability value, i.e. have a required probability level, the illustrative embodiments generate an alert or notification of the medical code candidates for coding. This operation may be performed in response to information indicating that the patient is scheduled for further treatment by the doctor or medical practitioner, e.g., the patient has a scheduled doctor visit in the doctor's scheduling system, and the alert/notification may be appended to the appointment entry in a scheduling system for further consideration by the doctor when interacting with the patient. For example, the scheduling of the patient's appointment may be a trigger event that is used to trigger the operation to search for potentially applicable medical codes. In such an embodiment, the medical codes that are determined to have a sufficiently high enough probability of being applicable to the patient may be added to the scheduled appointment entry in the scheduling system as alerts or notifications that are displayed or otherwise output to the doctor or medical practitioner (hereafter, simply the “doctor”) when the doctor appointment is being performed.

Other triggering events may also be used to initiate the operation of the illustrative embodiments including the entry, by a doctor or other medical practitioner, of a new medical code or diagnosis for the patient, a user request to search the patient's registry record to determine applicable medical codes, a scheduled event, such as a periodic check of patient registry records for applicable medical codes, or the like. For example, in response to a doctor entering into a patient registry record a new diagnosis and/or medical code for the patient, the mechanisms of the illustrative embodiments may be automatically initiated to analyze and evaluate the newly entered diagnosis and/or medical code, as well as its relationship with previous medical history information for the patient, to identify other potentially applicable medical codes, calculate their probabilities of being applicable to the particular patient, and generate/output alerts/notifications to the doctor or otherwise log these alerts/notifications in the patient's registry entry. For example, in response to the doctor entering a medical code into the doctor's computing system for modifying the patient's registry record, the mechanisms of the illustrative embodiments may operate to identify other medical codes applicable to the patient and output the corresponding alert/notification on the doctor's computing system prior to the patient leaving the doctor's office so that the doctor may consult with the patient to determine if the additional medical code(s) are applicable to the patient and should be coded in the patient's registry record. The doctor, in such a case, may have ultimate final approval as to whether the medical code(s) are added to the patient's registry record in association with the appointment as recorded in the patient's registry record. For example, the alert/notification may include graphical user interface (GUI) elements or the like that allow the doctor to select a GUI element to add the medical code to the patient's registry record or reject the addition of the medical code.

In some cases, the probability that a medical code applies to a patient may meet or exceed a predetermined threshold probability value indicative of a high confidence that the medical code should be added to the patient's registry record. In such a case, the medical code may be automatically entered into the patient's registry record through the alert/notification mechanisms of the illustrative embodiments and a corresponding alert/notification set to the doctor or other medical personnel indicating the automatic addition of the medical code to the patient's registry record. In such an embodiment, the alert/notification may include one or more GUI elements for accepting the automatic addition or otherwise initiating a roll-back of the automatic addition of the medical code to the patient's registry record.

The determination of the probability value associated with a medical code may comprise applying one or more coding rules to key characteristics in the patient registry record. These coding rules may be indicative of pre-requisites or conditions/criteria for the medical code to be potentially applicable to the patient. For example, a pre-requisite or condition/criteria may be a particular pattern of other medical codes in the patient history, particular pattern of symptoms, events, diagnoses, lab results, and the like, in the patient history, as well as combining such patterns in the patient history with current medical codes, symptoms, diagnoses, events, lab results, or the like. The pre-requisite or condition/criteria may further include timing aspects as well as identification of the actual elements required to be present in the patient registry record. Thus, for example, a coding rule may specify a pattern in which a first medical code is present, and then a second medical code is present within 6 months of the first medical code being present, and a third medical code is present prior to the first medical code being present in the patient registry record.

Such coding rules may further take into consideration third party information regarding a lifestyle of the particular patient as may be obtained from a variety of third party information sources. For example, communications exchanged by the patient via one or more electronic communication systems, e.g., email, text messaging, social network postings, and the like, may be analyzed using natural language processing and recognizable characteristics of the patient may be extracted from these communications to determine additional potential characteristics for triggering coding rules or at least evaluating the applicability of coding rules to the patient. Similarly, spatial information about the patient may be extracted from third party information sources to determine additional patient characteristics which may trigger a coding rule. For example, global positioning system (GPS) information, FitBit™ information, cellular triangulation information, airline, railway, and other travel company computing systems and/or applications associated with the patient may be analyzed to determine where the patient has traveled or routinely travels may be used to obtain additional information about the patient. The coding rules may include such characteristics as pre-requisites or conditions/criteria for evaluating the applicability of a medical code to the patient. For example, a coding rule may specify that if the patient has previously been diagnosed with a medical code A and has recently (within the last 3 months) traveled to South America, and currently has a high fever and chills, then a medical code B may be applicable to the patient.

It should be appreciated that any combination of patient characteristics, timing conditions, spatial conditions, third party lifestyle information, and the like, may be used as pre-requisites or conditions/criteria for evaluation as part of a coding rule. It should further be appreciated that when applying a coding rule, all of the pre-requisites and conditions/criteria may not be met by a particular patient's registry record and third party information but a portion of these pre-requisites or conditions/criteria may be met. Thus, a probability value may be calculated for the applicability of the corresponding medical code may be calculated based on a level of matching of the patient's registry records and third party information to the pre-requisites and conditions/criteria of the coding rule. For example, a percentage of the pre-requisites and conditions/criteria met may be calculated and used as a measure of the probability that the medical code associated with the coding rule is applicable to the patient. This measurement may be weighted such that various ones of the pre-requisites and conditions/criteria may be given different weights depending on their relative importance to the applicability of the medical code.

In response to analysis of the patient registry record data and/or third party information for the patient being initiated, the coding rules are applied to the patient registry record data and/or third party information to determine if patterns of occurrences of medical codes, diagnoses, symptoms, lab results, third party information indicative of patient characteristics, and the like, meet the pre-requisites and conditions/criteria specified by the coding rules. The coding rules identify different types of medical codes that are likely medical maladies or conditions that need to be coded by the doctor or medical professional in the patient's registry record. Thresholds may be established for determining which medical codes have a sufficiently high enough probability of applicability to the patient to warrant notification. The medical codes may be specified based on medical knowledge of the various medical maladies, payment provider guidelines, and the like. For example, it may be known from medical knowledge that type 2 diabetes is an ongoing medical malady that will persist from one year to the next and that it may be a condition that starts with an original diagnosis and medical code directed to frequent urination, headaches, blurred vision, previous diagnosis of high blood pressure, and the like. A coding rule may be established for evaluating each of these pre-requisites and conditions/criteria against the particular patient's registry record and third party information (if any) to determine a likelihood, or probability, that the medical code for type 2 diabetes applies to the patient. This likelihood, or probability, may be compared against a pre-determined threshold value to determine if the likelihood, or probability, is sufficiently high as to warrant a notification or alert.

Thus, for example, a coding rule may look to the patient's historical medical data in the patient's EMRs to determine if a medical code exists for high blood pressure. In response to finding a previous occurrence of a medical code for high blood pressure, the coding rule may further look for medical codes that have been entered into the patient's EMR in the most recent entry, and/or within a specified time period, e.g., the calendar year, directed to other symptoms of type 2 diabetes, e.g., headaches, fainting, blurred vision, particular lab results, etc. For each of the pre-requisites and conditions/criteria, corresponding measures are calculated for each of the pre-requisites and conditions/criteria to generate an ultimate probability value for the medical code associated with the coding rule. This probability value is compared to a threshold probability value and if the probability value of the coding rule equals or exceeds the threshold probability value, then an alert or notification may be appended or added to the scheduled appointment of the patient such that when the doctor or medical personnel is notified of the patient's scheduled appointment, the alert or notification of the potential need to code the patient with the applicable medical code is also output to the doctor/medical personnel. Alternatively, the alert or notification may be appended to the patients' registry record (e.g., EMRs), or sent to the doctor/medical personnel in a separate notification from the appointment scheduling, etc.

The identification of occurrences of patient characteristics corresponding to pre-requisites and conditions/criteria in the patient's historical medical data may be filtered according to date/time criteria such that only patient characteristics corresponding to pre-requisites and conditions/criteria that have occurred within a particular period of time may be considered as triggers for applying the coding rules, e.g., only patient characteristics that were recorded within the last 5 years may be considered. Such periods of time may be specific to the particular type of pre-requisite or condition/criteria as may be determined based on information indicative of how long a particular corresponding medical malady may persist, how long a particular payment provider's guidelines indicate the payment provider will compensate the doctor or medical personnel for treatment of the medical malady, or the like.

Moreover, the coding rules may look for complex patterns of medical codes, timing criteria between medical codes, and the like. For example, a coding rule may identify a previous coding of the patient in the patient's EMRs for a medical malady A, which in turn triggers an analysis of the patient's EMRs to determine if the patient was also coded with a medical code for medical malady B within a specified period of time after the entry of the medical code for medical malady A, which in turn triggers an analysis of the patient's EMRs to determine if the patient has been previously coded with a medical code for medical malady C within a second specified time period before the coding of medical malady B. If the pattern of medical codes exist in the patient's historical medical data in the patient's EMRs, then a corresponding medical coding recommendation is output, e.g., added to a patient's scheduled appointment or otherwise sent as an alert or notification to the doctor or medical personnel.

Based on the alert or notification output by the mechanisms of the illustrative embodiments, the doctor or other medical personnel can evaluate whether to code the medical code in the patient's EMRs such that coding is not necessarily automatically performed. This is because some medical codes, while having a high probability of applicability, may in fact not be applicable in the doctor or medical personnel's estimation. In some cases, coding of a medical code may be performed automatically and the alert or notification may indicate that that the medical code has been automatically coded and provide the doctor or medical personnel options to override the automatic coding of the medical code. The automatic coding may be medical code specific such that some medical codes are automatically coded while others are not. As a result, some alerts/notifications may specify that a medical code has been automatically coded while other alerts/notifications may specify that a medical code is a candidate for coding at the doctor or medical personnel's authorization. Interface elements may be provided, based on the nature of the alert/notification, to either override the automatic coding of the medical code or to initiate coding of the medical code in the patient's EMRs. In some cases, automatic coding may be based on the level of probability calculated for the applicability of the medical code, e.g., if the probability is 95%, a threshold may be established that states any probability values at 95% or higher are automatically coded to the patient's EMR.

Thus, with the mechanisms of the illustrative embodiments, doctors and medical personnel are informed of potentially applicable medical codes, based on a calculation of a probability of applicability of the medical codes, for a patient such that they may evaluate whether such coding should be performed. In some instances, coding of medical codes may be automatically performed. In some illustrative embodiments, final decision making regarding coding is provided to the doctor or medical personnel via interface elements for overriding or authorizing the coding of the medical code. In this way, doctors and medical personnel are given greater opportunities to ensure that they are properly compensated for the care that they are providing as well as correctly coding the patient with applicable medical codes.

From the above general overview of the mechanisms of the illustrative embodiments, it is clear that the illustrative embodiments are implemented in a computing system environment and thus, the present invention may be implemented as a data processing system, a method implemented in a data processing system, and/or a computer program product that, when executed by one or more processors of one or more computing devices, causes the processor(s) to perform operations as described herein with regard to one or more of the illustrative embodiments. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As shown in the figures, and described hereafter, one or more computing devices comprising a distributed data processing system, may be specifically configured to implement a personalized patient care plan system in accordance with one or more of the illustrative embodiments. The configuring of the computing device(s) may comprise the providing of application specific hardware, firmware, or the like to facilitate the performance of the operations and generation of the outputs described herein with regard to the illustrative embodiments. The configuring of the computing device(s) may also, or alternatively, comprise the providing of software applications stored in one or more storage devices and loaded into memory of a computing device for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of one or more of the illustrative embodiments and is not a general purpose computing device. Moreover, as described hereafter, the implementation of the mechanisms of the illustrative embodiments improves the functionality of the computing device(s) and provides a useful and concrete result that facilitates creation, monitoring, and adjusting personalized patient care plans based on personalized lifestyle information and assessment of patient adherence to the personalized patient care plan.

As mentioned above, the mechanisms of the illustrative embodiments may be implemented in many different types of data processing systems, both stand-alone and distributed. Some illustrative embodiments implement the mechanisms described herein in a cloud computing environment. It should be understood in advance that although a detailed description on cloud computing is included herein, implementation of the teachings recited herein are not limited to a cloud computing environment. Rather, embodiments of the present invention are capable of being implemented in conjunction with any other type of computing environment now known or later developed. For convenience, the Detailed Description includes the following definitions which have been derived from the “Draft NIST Working Definition of Cloud Computing” by Peter Mell and Tim Grance, dated Oct. 7, 2009.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics of a cloud model are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models of a cloud model are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models of a cloud model are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes. A node in a cloud computing network is a computing device, including, but not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. A cloud computing node is capable of being implemented and/or performing any of the functionality set forth hereinabove.

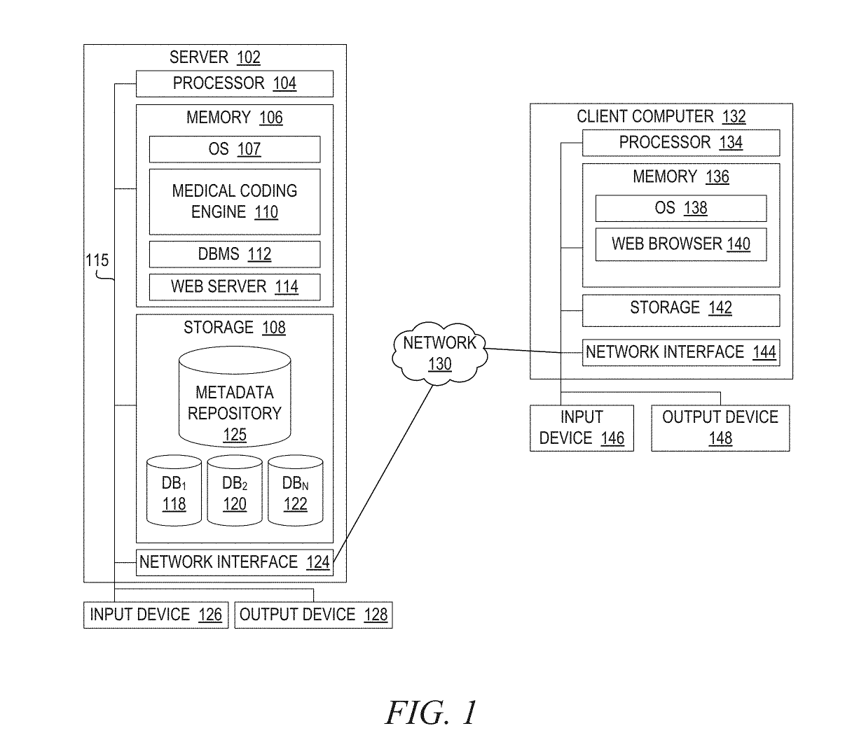

FIG. 1 is a block diagram illustrating a cloud computing system 100 for providing software as a service, where a server provides applications and stores data for multiple clients in databases according to one example embodiment of the invention. The networked system 100 includes a server 102 and a client computer 132. The server 102 and client 132 are connected to each other via a network 130, and may be connected to other computers via the network 130. In general, the network 130 may be a telecommunications network and/or a wide area network (WAN). In a particular embodiment, the network 130 is the Internet.

The server 102 generally includes a processor 104 connected via a bus 115 to a memory 106, a network interface device 124, a storage 108, an input device 126, and an output device 128. The server 102 is generally under the control of an operating system 107. Examples of operating systems include UNIX, versions of the Microsoft Windows™ operating system, and distributions of the Linux™ operating system. More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 124 may be any type of network communications device allowing the server 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices.

As shown, the storage 108 of the server contains a plurality of databases. In this particular drawing, four databases are shown, although any number of databases may be stored in the storage 108 of server 102. Storage 108 is shown as containing databases numbered 118, 120, and 122, each corresponding to different types of patient related data, e.g., electronic medical records (EMRs) and demographic information, lifestyle information, treatment guidelines, personalized patient care plans, and the like, for facilitating the operations of the illustrative embodiments with regard to personalized patient care plan creation, monitoring, and modification. Storage 108 is also shown containing metadata repository 125, which stores identification information, pointers, system policies, and any other relevant information that describes the data stored in the various databases and facilitates processing and accessing the databases.

The input device 126 may be any device for providing input to the server 102. For example, a keyboard and/or a mouse may be used. The output device 128 may be any device for providing output to a user of the server 102. For example, the output device 108 may be any conventional display screen or set of speakers. Although shown separately from the input device 126, the output device 128 and input device 126 may be combined. For example, a display screen with an integrated touch-screen may be used.

As shown, the memory 106 of the server 102 includes a medical coding engine application 110 configured to provide a plurality of services to users via the network 130. As shown, the memory 106 of server 102 also contains a database management system (DBMS) 112 configured to manage a plurality of databases contained in the storage 108 of the server 102. The memory 106 of server 102 also contains a web server 114, which performs traditional web service functions, and may also provide application server functions (e.g. a J2EE application server) as runtime environments for different applications, such as the medical coding engine application 110.

As shown, client computer 132 contains a processor 134, memory 136, operating system 138, storage 142, network interface 144, input device 146, and output device 148, according to an embodiment of the invention. The description and functionality of these components is the same as the equivalent components described in reference to server 102. As shown, the memory 136 of client computer 132 also contains web browser 140, which is used to access services provided by server 102 in some embodiments.

The particular description in FIG. 1 is for illustrative purposes only and it should be understood that the invention is not limited to specific described embodiments, and any combination is contemplated to implement and practice the invention. Although FIG. 1 depicts a single server 102, embodiments of the invention contemplate any number of servers for providing the services and functionality described herein. Furthermore, although depicted together in server 102 in FIG. 1, the services and functions of the medical coding engine application 110 may be housed in separate physical servers, or separate virtual servers within the same server. The medical coding engine application 110, in some embodiments, may be deployed in multiple instances in a computing cluster. The modules performing their respective functions for the medical coding engine application 110 may be housed in the same server, on different servers, or any combination thereof. The items in storage, such as metadata repository 125, databases 118, 120, and 122, may also be stored in the same server, on different servers, or in any combination thereof, and may also reside on the same or different servers as the application modules.

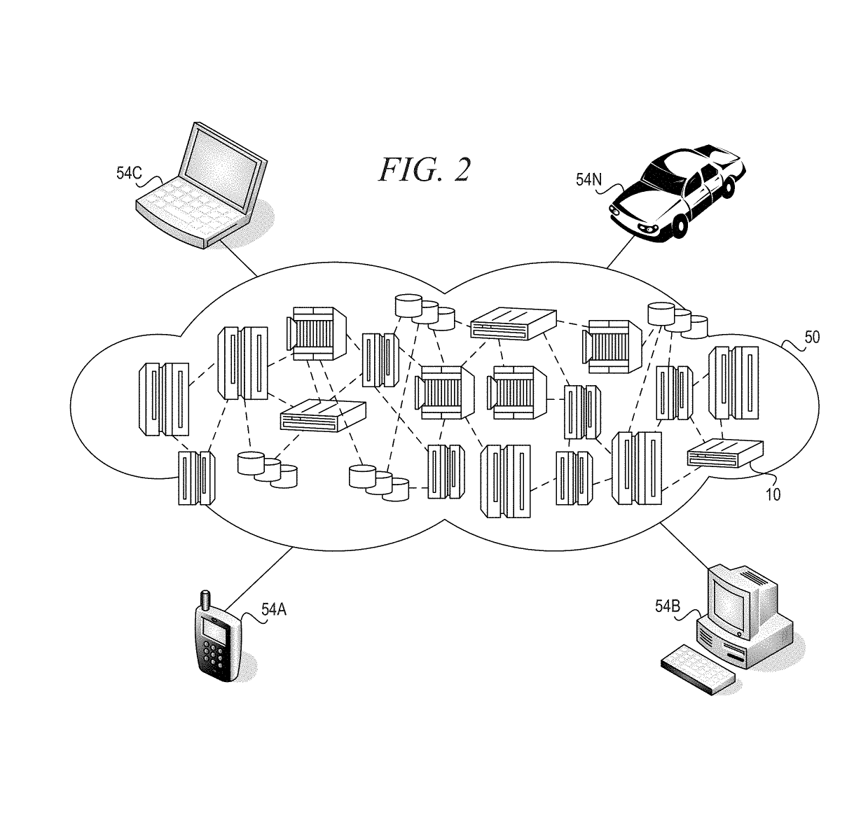

Referring now to FIG. 2, another perspective of an illustrative cloud computing environment 250 is depicted. As shown, cloud computing environment 250 comprises one or more cloud computing nodes 210, which may include servers such as server 102 in FIG. 1, with which local computing devices used by cloud consumers, such as, for example, personal digital assistant (PDA) or cellular telephone 254A, desktop computer 254B, laptop computer 254D, and/or automobile computer system 254N may communicate. Nodes 210 may communicate with one another. A computing node 210 may have the same attributes as server 102 and client computer 132, each of which may be computing nodes 210 in a cloud computing environment. They may be grouped (not shown) physically or virtually, in one or more networks, such as Private, Community, Public, or Hybrid clouds as described hereinabove, or a combination thereof. This allows cloud computing environment 250 to offer infrastructure, platforms and/or software as services for which a cloud consumer does not need to maintain resources on a local computing device. It is understood that the types of computing devices 254A-N shown in FIG. 2 are intended to be illustrative only and that computing nodes 210 and cloud computing environment 250 can communicate with any type of computerized device over any type of network and/or network addressable connection (e.g., using a web browser).

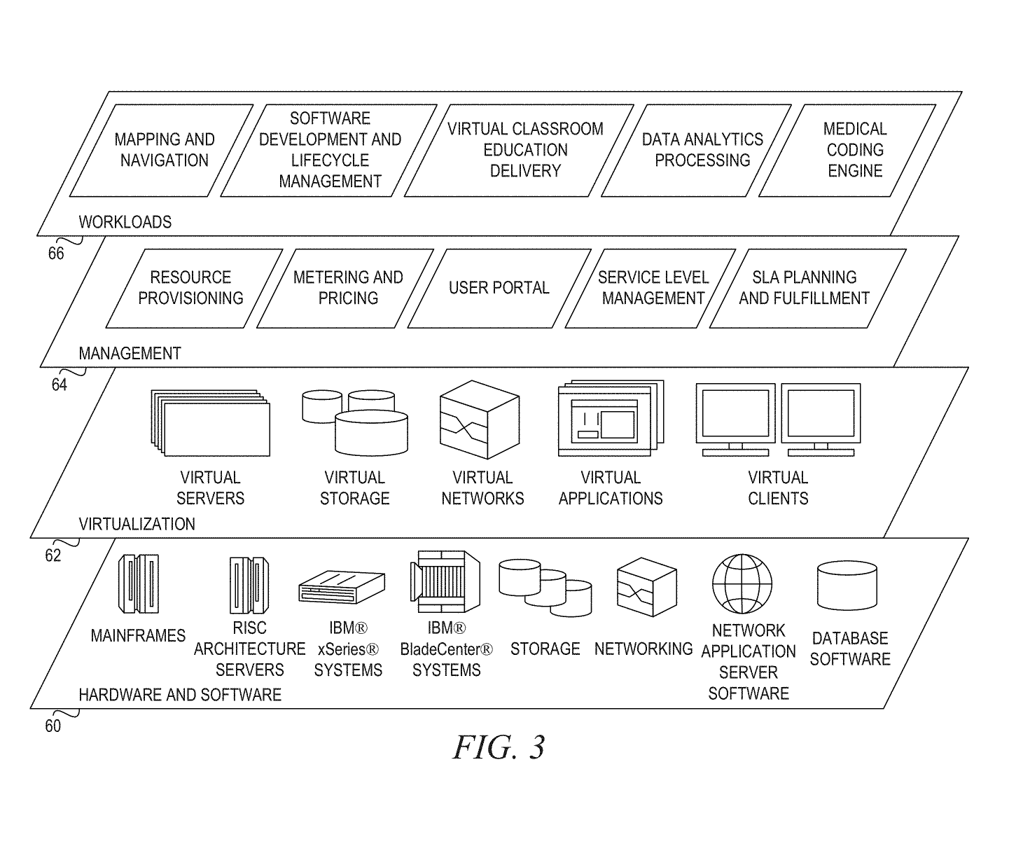

Referring now to FIG. 3, a set of functional abstraction layers provided by cloud computing environment 250 (FIG. 2) is shown. It should be understood in advance that the components, layers, and functions shown in FIG. 3 are intended to be illustrative only and embodiments of the invention are not limited thereto. As depicted, the following layers and corresponding functions are provided.

The hardware and software layer 360 includes hardware and software components. Examples of hardware components include mainframes, in one example IBM™ zSeries™ systems; RISC (Reduced Instruction Set Computer) architecture based servers, in one example IBM pSeries™ systems; IBM xSeries™ systems; IBM BladeCenter™ systems; storage devices; networks and networking components. Examples of software components include network application server software, in one example IBM Web Sphere™ application server software; and database software, in one example IBM DB2™ database software. (IBM, zSeries, pSeries, xSeries, BladeCenter, WebSphere, and DB2 are trademarks of International Business Machines Corporation registered in many jurisdictions worldwide.).

The virtualization layer 362 provides an abstraction layer from which the following examples of virtual entities may be provided: virtual servers; virtual storage; virtual networks, including virtual private networks; virtual applications and operating systems; and virtual clients. In one example, management layer 364 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 366 provides examples of functionality for which the cloud computing environment may be utilized. Examples of workloads and functions which may be provided from this layer include: mapping and navigation; software development and lifecycle management; virtual classroom education delivery; data analytics processing; transaction processing; and, in accordance with the mechanisms of the illustrative embodiments, a medical coding engine functionality.

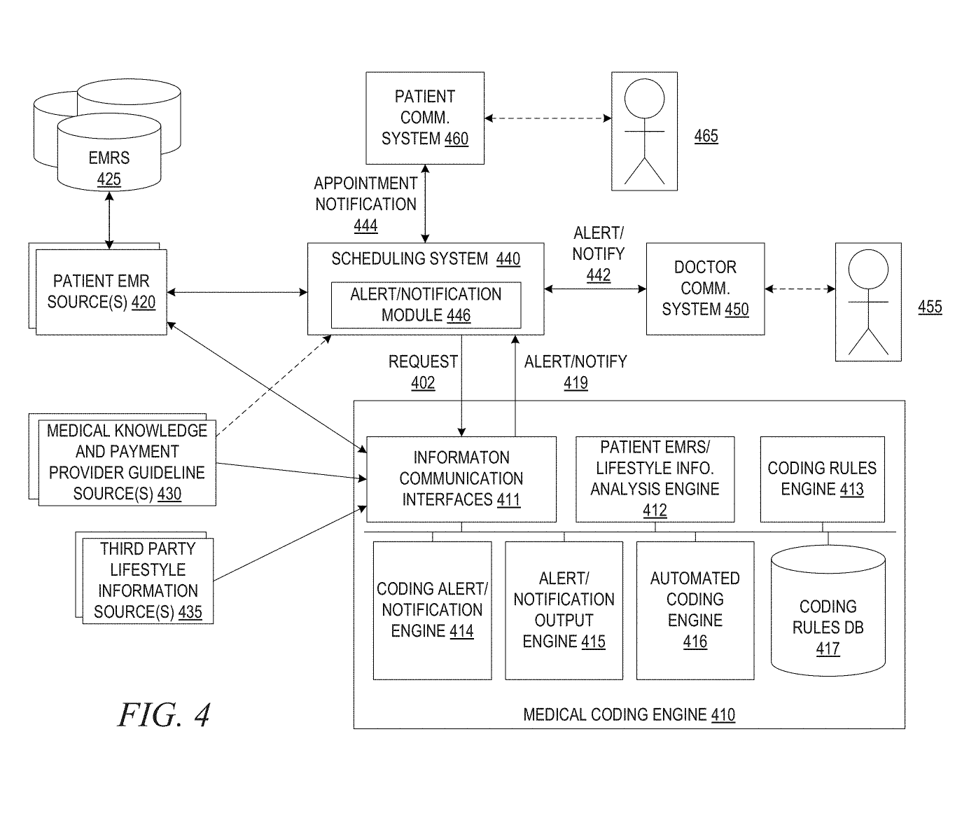

As discussed above, the illustrative embodiments provide a medical coding engine which may be implemented in various types of data processing systems. FIG. 4 is an example block diagram illustrating the primary operational elements of such a medical coding engine in accordance with one illustrative embodiment. The operational elements shown in FIG. 4 may be implemented as specialized hardware elements, software executing on hardware elements, or any combination of specialized hardware elements and software executing on hardware elements without departing from the spirit and scope of the present invention.

As shown in FIG. 4, the primary operational elements comprise a medical coding engine 410, one or more patient electronic medical record (EMR) sources 420, one or more medical knowledge and payment provider guideline sources 430, third party lifestyle information source(s) 435, a scheduling system 440, a doctor communication system 450, and a patient communication system 460. It should be appreciated that while the elements 410-460 are illustrated as separate elements in FIG. 4, the illustrative embodiments are not limited to such. Rather, many of the elements shown in FIG. 4 may be integrated with one another without departing from the spirit and scope of the illustrative embodiments. For example, in some illustrative embodiments, the patient EMR sources 420, scheduling system 440, and medical coding engine 410 may all be integrated with one another so as to provide a single suite of tools that may be executed or otherwise implemented using one or more data processing systems. This single suite of tools may be deployed at a single medical practice location and corresponding data processing systems, in a centralized or distributed fashion in association with multipole medical practices and locations, or any other suitable deployment configuration.

The medical coding engine 410 provides the various engines and logic for evaluating patient electronic medical records (EMRs), third party lifestyle information, and the like, to determine instances of patient characteristics associated with a patient that are indicative of medical codes that are applicable candidates for coding. The patient's EMRs 425 are provided by one or more patient EMR sources 420 to the medical coding engine 410 via the information communication interfaces 411 as is the third party lifestyle information from the third party lifestyle information source(s) 435. The information communication interfaces 411 provides one or more data communication interfaces through which patient data may be obtained from various patient EMR data sources 420 as well as medical knowledge and payment provider guideline sources 430 and the third party lifestyle information from the third party lifestyle information source(s) 435. Moreover, the interfaces 411 comprise interfaces for interfacing with a scheduling system 440 to receive requests 402 to initiate evaluations for medical coding and provide alerts/notifications 419 of candidate medical codes for coding or medical codes that have automatically been coded.

The EMR data sources 420 may comprise various sources of electronic medical records including individual doctor medical practice systems, hospital computing systems, medical lab computing systems, personal patient devices for monitoring health of the patient, dietary information, and/or activity information of the patient, or any other source of medical data that represents a particular patient's current and historical medical condition. The EMR data sources 420 may further comprise data representing the patient demographics since such information is typically gathered by providers of such medical data. The third party lifestyle information source(s) 435 may comprise any source of information that is indicative of a lifestyle of the patient outside of conventional medical records. For example, this lifestyle information may comprise communications exchanged by the patient via one or more communication services, social networking website participation information and user profiles, and the like.

In accordance with the illustrative embodiments, the patient EMRs represent patient medical history information that is evaluated by the medical coding engine 410 to determine whether any medical codes associated with coding rules are candidates for coding. As mentioned above, this evaluation may further include evaluating other third party information, demographic information for the patient, and the like.

The medical knowledge and payment provider guideline sources 430 provide information to the medical coding engine 410 indicating general medical knowledge regarding various medical maladies from established medical knowledge bases as well as information regarding policies of various payment providers as specified in payment provider guidelines. For example, the medical knowledge may comprise medical knowledge bases, either in a structured format or a natural language format, which provide, among other information, the persistency of medical maladies, pre-requisites or patterns of patient characteristics indicative of medical maladies, comorbidities, and the like. This information may be used by the medical code re-coding engine 410 to determine whether a particular medical malady associated with a medical code is a pre-requisite or condition/criteria corresponding to a pre-requisite or condition/criteria of a coding rule, for example. In the case of comorbidities, this information may be used to trigger the medical coding engine 410 to look for additional medical codes in the patient's EMRs 425 and/or identify additional coding rules that may be applicable to the patient.

With regard to payment provider guidelines, the medical knowledge and payment provider guideline sources 430 may provide information indicating the guidelines that payment providers have established for compensating medical care providers for the treatment of patients. For example, a guideline may be of the type that a flat fee of $X is paid to a doctor on a calendar year basis for each type 2 diabetes patient that the doctor treats while a flat fee of $Y is paid to the doctor on a calendar year basis if the type 2 diabetes patient is also an amputee. Other guidelines may indicate that the payment provider authorizes payment of $Z each time the doctor has a scheduled appointment with a patient coded with a medical code Q. Many different types of guidelines may be established by the payment providers for compensating medical care providers and each payment provider may have their own established guidelines. These guidelines are provided to the medical coding engine 410 for use in determining which medical code are applicable to a patient in the patient's EMR, or comorbidities of medical maladies associated with medical codes that are candidates for coding, as described hereafter.

The scheduling system 440 comprises a computing system used for scheduling appointments between the doctor(s)/medical personnel and patients. Various types of computing system based appointment scheduling systems are generally known in the art. The mechanisms of the illustrative embodiments augment such scheduling systems 440 to include an alert/notification module 446 which operates in concert with the medical coding engine 410 to provide alerts/notifications of automatically applied codings or candidates for coding, as well as provide interfaces through which a doctor/medical personnel (hereafter referred to simply as the “doctor”) may confirm, reject, or otherwise authorize/deny coding of a medical code identified as a candidate for coding by the medical coding engine 410.

The scheduling system 440 may send communications to a doctor communication system 450 and patient communication system 460 in any suitable communication form, e.g., automated telephone call, electronic mail message, instant message, text message, scheduling system 440 proprietary message output, or the like. The doctor communication system 450 and patient communication system 460 may comprise any suitable communication system including desktop and portable or tablet type computing devices, smart phones, personal digital assistants, conventional telephones, or the like. In one illustrative embodiment, the patient communication system 460 and doctor communication system 450 are computing devices.

With regard to the communications sent to the doctor communication system 450, the communications informing the doctor of a scheduled appointment with a patient may include additional alerts/notifications 442 of medical codes determined to be candidates for coding as determined by the medical coding engine 410 and integrated into the scheduled appointment by the alert/notification module 446. In some illustrative embodiments, the communications may inform the doctor of a medical code having been automatically coded by the medical coding engine 410. In both cases, user interface elements may be provided for allowing the doctor to confirm/reject or authorize/deny the coding that is proposed or already automatically performed. The alert/notification module 446 of the scheduling system 440 may receive doctor inputs from the doctor 455 and determine whether to code a medical code based on the doctor's input or not record the medical code. Moreover, in some illustrative embodiments, the alert/notification module 446 may determine whether to roll-back a previously automatically coded medical code in response to the doctor 455 input. The alert/notification module 446, based on the doctor 455 input, may communicate with the medical coding engine 410 to cause the medical codes that are candidates for coding to be coded in the patient's EMR 425 or previous updates to code the medical code rolled-back.

With regard to communications sent to the patient 465, the appointment notification 444 is sent to the patient communication system 460 to inform the patient 465 of their scheduled appointment. This appointment notification 444 does not include the alerts/notifications of candidate medical codes for coding as with the communications sent to the doctor 455.

With regard to the operation of the medical coding engine 410, the patient EMRs/lifestyle information analysis engine 412, and optionally the third party lifestyle information from sources 435, in response to a trigger event (patient scheduling an appointment, elapse of specified time period such as a payment provider's medical treatment compensation time period, user initiated request, or the like), identifies instances of patient characteristics in a patient EMR 425 and/or lifestyle information that are indicative of medical codes which are candidates for coding in the patient EMR. In some illustrative embodiments, medical knowledge and payment provider guidelines may further indicate to the patient EMRs/lifestyle information analysis engine 412 possible comorbidities that are potential candidates for coding in the patient EMR 425.

In response to analysis of the patient EMRs 425/lifestyle information being initiated, coding rules from the coding rules database 417 are applied to the identified occurrences of the patient characteristics in the patient's EMRs 425, and optionally the lifestyle information from sources 435, to determine if patterns of occurrences of patient characteristics meet the pre-requisites and conditions/criteria specified by the coding rules. The coding rules identify different types of medical codes for medical maladies or conditions that may need to be coded by the doctor 455. Such medical codes may be specified based on medical knowledge of the various medical maladies, payment provider guidelines, and the like, such as obtained from the medical knowledge and payment provider guideline sources 430. The coding rules themselves may be automatically generated from a natural language processing of this information from sources 430 or from a subject matter expert or other user that manually constructs the rules and stores them as part of the coding rules database 417.

The coding rules engine 413 applies the coding rules in the coding rules database 417 to the occurrences of patient characteristics identified by the patient EMRs/lifestyle information analysis engine 412 that are present in the patient's EMR 425, and optionally the lifestyle information from sources 435, to determine if pre-requisites, criteria or conditions of the coding rules are satisfied and the level or extent to which these pre-requisites, criteria, or conditions are satisfied. That is, a degree of matching between the patient characteristics and the pre-requisites or conditions/criteria is measured to generate a probability value that the corresponding medical code applies to the patient. This probability value may then be compared against one or more threshold probability values to determine whether to create an alert/notification, automatically code the medical code in the patient's EMR 425, or perform other appropriate action. In response to determining that the probability value of a coding rule is sufficiently high, e.g., meets or exceeds a pre-determined threshold probability value, then an alert or notification may be appended or added to appointment information for the patient via the scheduling system 440 such that when the doctor 455 is notified of the patient's scheduled appointment via the doctor communication system 450, the alert or notification 442 of the potential need to code the patient's medical malady is also output to the doctor 455 via the scheduling system 440.

The coding rules engine 413 may apply coding rules 417 to occurrences of patient characteristics found by the patient EMRs/lifestyle information analysis engine 412 which look for complex patterns of medical codes and other patient characteristics, as well as timing criteria between medical codes/patient characteristics, and the like. The coding rules engine 413 may work in conjunction with the patient EMRs/lifestyle information analysis engine 412 to analyze the patient EMRs 425/lifestyle information to identify whether such patterns exist in the patient's EMRs 425/lifestyle information. If the pattern of medical codes, patient characteristics, timings between codes/patient characteristics, and other pattern criteria exist, e.g., specific patient demographics being present, in the patient's historical medical data in the patient's EMRs 425/lifestyle information, then the coding alert/notification engine 414 is signaled to generate a corresponding medical coding recommendation. This alert/notification is output by the alert/notification output engine 415 to the alert/notification module 446 of the scheduling system 440 is output, e.g., added to a patient's scheduled appointment or otherwise sent as an alert or notification to the doctor 455.

Based on the alert or notification 442 output by the scheduling system 440 to the doctor communication system 450, the doctor 455 is given information to evaluate whether to code the medical code in the patient's EMRs 425 such that coding is not necessarily automatically performed. In some cases, coding of a medical code may be performed automatically by the automated coding engine 416 and the alert or notification 442 may indicate that that the medical code has been automatically coded and provide the doctor 455 graphical user interface elements or options to override the automatic coding of the medical code already performed by the automated coding engine 416. The automatic coding may be medical code specific such that some medical codes are automatically coded while others are not with such determinations being performed by the automated coding engine 416 when it is informed of the decision of the coding rules engine 413 that the medical code is a candidate for coding. The actual automatic coding may be performed with the patient EMR sources 420 via the information communication interfaces 411.

As a result, some alerts/notifications 442 may specify that a medical code has been automatically coded while other alerts/notifications 442 may specify that a medical code is a candidate for coding at the doctor's authorization. Interface elements may be provided, based on the nature of the alert/notification 442, to either override the automatic coding of the medical code or to initiate coding of the medical code in the patient's EMRs 425.

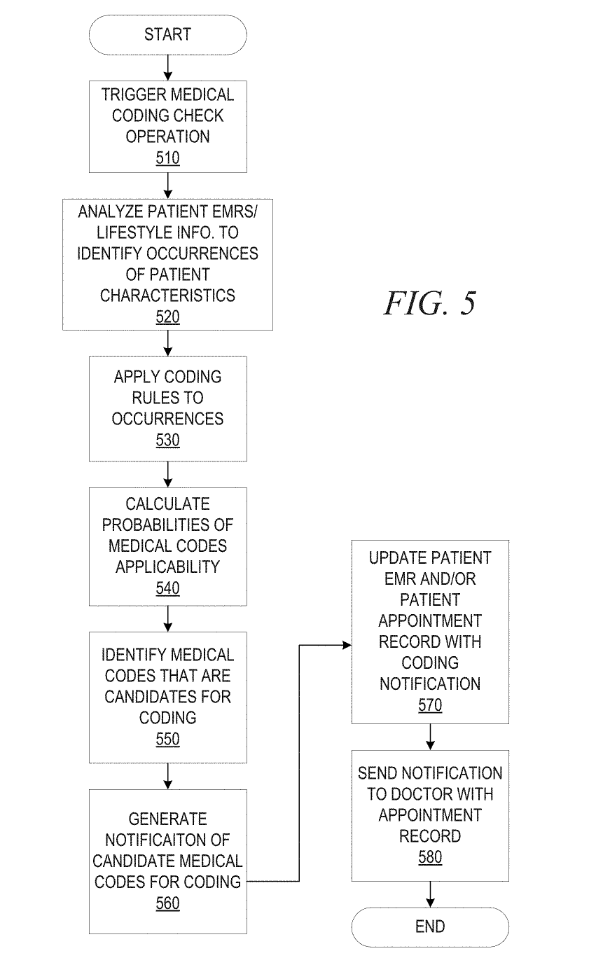

FIG. 5 is a flowchart outlining an example operation for generating notifications of medical code re-coding opportunities in accordance with one illustrative embodiment. The operation outlined in FIG. 5 may be implemented, for example, by a medical code re-coding engine, such as medical code re-coding engine 410 in FIG. 4. As shown in FIG. 5, the operation starts with the medical coding check operation being triggered for a specified patient (step 510). As noted above, this trigger may comprise the occurrence of a particular event, a user input requesting that the coding check operation be initiated, the elapse of a specific time period, a patient scheduling an appointment with a doctor or other medical personnel, or any other suitable trigger event.

In response to the operation being triggered, the patient's EMRs, and optionally lifestyle information, are retrieved and analyzed to identify occurrences of medical codes/patient characteristics in the patient's EMRs/lifestyle information (step 520). Coding rules are applied and evaluated to determine which elements of each of the coding rules are satisfied by the information in the patient's EMRs and lifestyle information (step 530). The coding rules may be automatically generated from natural language processing of medical knowledge, payment provider guidelines, or the like. Alternatively, the coding rules may be manually generated by subject matter experts. The coding rules may be part of a coding rule database and may be associated with particular medical codes for particular payment providers. Thus, a coding rule is matched to occurrences of medical codes/patient characteristics based and identifies an associated medical code.

A probability that a corresponding medical code applies to the patient is calculated for each of the coding rules (step 540). Based on the probability values calculated for each of the coding rules, it is determined whether the corresponding medical code applies by comparing the probability value to one or more threshold values. For those coding rules whose corresponding probability values meet or exceed the one or more threshold values, the corresponding medical codes are identified as medical codes that are candidates for coding (step 550) while those that do not match the specified patterns to a sufficient degree, e.g., high enough probability value, are not identified as candidates for coding.

A notification of the candidates for coding is generated (step 560). The notification is then added to or appended to the patient's EMRs, a patient appointment record in a scheduling system, or otherwise output for review by a doctor or other medical personnel (step 570). In other illustrative embodiments, a step (not shown) of automatically applying the coding may be performed and the notification may indicate that the coding was already performed and give the doctor an opportunity to roll-back the coding. The notification is sent to the doctor (step 580). In the depicted example operation, the notification is sent as part of the appointment record, however the illustrative embodiments are not limited to such and any suitable form of output to the doctor may be used without departing from the spirit and scope of the illustrative embodiments.

Thus, with the mechanisms of the illustrative embodiments, doctors and medical personnel are informed of potentially applicable medical codes for a patient such that they may evaluate whether such coding should be performed. In this way, doctors and medical personnel are given greater opportunities to ensure that they are properly compensated for the care that they are providing and the patients are coded with all applicable medical codes. It should be appreciated that there are other reasons for identifying potentially applicable medical codes for a patient other than, or in addition to, proper compensation of doctors and other medical personnel/practitioners including, but not limited to, risk categorization, determining whether a patient is a candidate for a treatment, medical procedure, medical testing, enrollment in a medical trial, or the like. The illustrative embodiments are not limited to determining potential applicability of medical codes for only monetary compensation purposes and may be used for any suitable reason deemed appropriate for the particular implementation.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, for identifying potential medical codes applicable to a patient based on a patient registry record, comprising:
analyzing, by the data processing system, a patient registry record in a patient registry to identify current and historical medical information about a corresponding patient;
evaluating, by the data processing system, the current and historical medical information to identify at least one medical code for which the patient may qualify but is not currently associated with the patient;
calculating, by the data processing system, a probability value for the at least one medical code based on the current and historical medical information about the corresponding patient, wherein the probability value indicates a probability that the at least one medical code applies to the patient;
comparing, by the data processing system, the probability value to at least one threshold value; and
outputting, by the data processing system, an alert notification indicating the at least one medical code in response to the probability value having a predetermined relationship with the at least one threshold value.

2. The method of claim 1, wherein the method is performed in response to a determination that the corresponding patient has scheduled an appointment with a medical practitioner, and wherein the outputting of the alert notification comprises outputting the alert notification as part of a notification of the scheduled appointment.

3. The method of claim 1, wherein the method is performed in response to an addition of a medical code to the patient registry record.

4. The method of claim 3, wherein evaluating the current and historical medical information comprises evaluating the historical medical information with regard to relationships between the historical medical information to the added medical code to identify other potentially applicable medical codes.

5. The method of claim 1, wherein the alert notification comprises one or more graphical user interface elements for operation by a user to confirm or reject addition of the at least one medical code to the patient registry record.

6. The method of claim 1, further comprising:
determining, by the data processing system, whether or not the predetermined relationship with the at least one threshold value indicates a relatively high probability that the at least one medical code is applicable to the corresponding patient; and
in response to determining that the predetermined relationship with the at least one threshold value indicates a relatively high probability that the at least one medical code is applicable to the corresponding patient, automatically adding the at least one medical code to the patient registry record.

7. The method of claim 6, wherein the alert notification comprises a graphical user element that is selectable by a user to roll-back the automatic addition of the at least one medical code to the patient registry record, and wherein, in response to a user selecting the graphical user element, the at least one medical code is removed from the patient registry record.

8. The method of claim 1, wherein calculating the probability value for the at least one medical code based on the current and historical medical information about the corresponding patient comprises:
applying one or more coding rules to key characteristics in the patient registry record; and
evaluating whether pre-requisites, conditions, or criteria specified in the one or more coding rules are satisfied by the key characteristics in the patient registry record.

9. The method of claim 8, wherein the key characteristics comprise at least one of required symptoms, medical events, required diagnoses, or required lab results for the pre-requisites, conditions, or criteria specified in the one or more coding rules to be satisfied.

10. The method of claim 8, wherein the pre-requisites, conditions, or criteria specified in the one or more coding rules define a pattern of key characteristics with temporal requirements between the key characteristics.

11. A computer program product comprising a computer readable storage medium having a computer readable program stored therein, wherein the computer readable program, when executed in a data processing system, causes the data processing system to:
analyze a patient registry record in a patient registry to identify current and historical medical information about a corresponding patient;
evaluate the current and historical medical information to identify at least one medical code for which the patient may qualify but is not currently associated with the patient;
calculate a probability value for the at least one medical code based on the current and historical medical information about the corresponding patient, wherein the probability value indicates a probability that the at least one medical code applies to the patient;
compare the probability value to at least one threshold value; and
output an alert notification indicating the at least one medical code in response to the probability value having a predetermined relationship with the at least one threshold value.

12. The computer program product of claim 11, wherein the computer readable program is executed by the data processing system in response to a determination that the corresponding patient has scheduled an appointment with a medical practitioner, and wherein the outputting of the alert notification comprises outputting the alert notification as part of a notification of the scheduled appointment.

13. The computer program product of claim 11, wherein the computer readable program is executed by the data processing system in response to an addition of a medical code to the patient registry record.

14. The computer program product of claim 13, wherein the computer readable program causes the data processing system to evaluate the current and historical medical information at least by evaluating the historical medical information with regard to relationships between the historical medical information to the added medical code to identify other potentially applicable medical codes.

15. The computer program product of claim 11, wherein the alert notification comprises one or more graphical user interface elements for operation by a user to confirm or reject addition of the at least one medical code to the patient registry record.

16. The computer program product of claim 11, wherein the computer readable program further causes the data processing system to:
determine whether or not the predetermined relationship with the at least one threshold value indicates a relatively high probability that the at least one medical code is applicable to the corresponding patient; and
in response to determining that the predetermined relationship with the at least one threshold value indicates a relatively high probability that the at least one medical code is applicable to the corresponding patient, automatically add the at least one medical code to the patient registry record.

17. The computer program product of claim 16, wherein the alert notification comprises a graphical user element that is selectable by a user to roll-back the automatic addition of the at least one medical code to the patient registry record, and wherein, in response to a user selecting the graphical user element, the at least one medical code is removed from the patient registry record.

18. The computer program product of claim 11, wherein the computer readable program further causes the data processing system to calculate the probability value for the at least one medical code based on the current and historical medical information about the corresponding patient at least by:
applying one or more coding rules to key characteristics in the patient registry record; and
evaluating whether pre-requisites, conditions, or criteria specified in the one or more coding rules are satisfied by the key characteristics in the patient registry record.

19. The computer program product of claim 18, wherein the pre-requisites, conditions, or criteria specified in the one or more coding rules define a pattern of key characteristics with temporal requirements between the key characteristics.

20. An apparatus comprising:
a processor; and
a memory coupled to the processor, wherein the memory comprises instructions which, when executed by the processor, cause the processor to:
analyze a patient registry record in a patient registry to identify current and historical medical information about a corresponding patient;
evaluate the current and historical medical information to identify at least one medical code for which the patient may qualify but is not currently associated with the patient;
calculate a probability value for the at least one medical code based on the current and historical medical information about the corresponding patient, wherein the probability value indicates a probability that the at least one medical code applies to the patient;
compare the probability value to at least one threshold value; and
output an alert notification indicating the at least one medical code in response to the probability value having a predetermined relationship with the at least one threshold value.
